(19) United States
(12) Patent Application Publication
(10) Pub. No.: US 2012/0119661 A1
(43) Pub. Date: May 17, 2012

(54) LIGHT EMITTING DIODE OPERATING DEVICE AND METHOD

(75) Inventor: Peter Müller, Mering (DE)

(73) Assignee: DELO INDUSTRIAL ADHESIVES LLC, Hauppauge, NY (US)

(21) Appl. No.: 12/951,493

(22) Filed: Nov. 22, 2010

Related U.S. Application Data
(60) Provisional application No. 61/264,320, filed on Nov. 25, 2009.

(51) Int. Cl. H05B 37/02; F21V 21/00

(52) U.S. Cl. 315/158; 362/382; 315/307; 315/309

(57) ABSTRACT

A light emitting diode (LED) operating device comprises an LED module and an operating unit. The LED module, including light emitting diodes to emit incoherent radiation, is connected in releasable manner to the operating unit by a connector. The operating unit incorporates a power supply and a controller to provide the LEDs with electrical power. Sensors in the operating unit and the LED module record operational parameters of the operating device, which are used together with characteristic parameters stored in an electronic memory device, to record and control the emission characteristic of the LED module.

### FIELD OF THE INVENTION

This invention relates to the field of light sources, and in particular to light sources based on light emitting diodes.

### BACKGROUND OF THE INVENTION

Light emitting diodes, in short LEDs, are becoming more and more important as light sources, not only in general lighting, but also in automotive or industrial applications. LED technology gained its increasing importance especially because of the outstanding properties of LEDs, when compared with conventional light sources.

Their operating lifetime is significantly longer and they have a relatively narrow bandwidth emission spectrum, making them highly efficient in applications, which make use of only a very specific part of the electromagnetic spectrum. Moreover, by choosing the right type of semiconductor, peak wavelengths may be varied from deep UV far into the infrared spectral range. Like most semiconductor components they are very small in size, allowing easy mechanical integration in any configuration needed. And last not least their output intensity may be varied arbitrarily by the amplitude of the operating current without any time delay.

Because of these properties, LEDs gained access to critical applications requiring precisely defined light sources in terms of output intensity and emission spectrum.

Technical applications of photochemical or photophysical reactions are among the examples for such critical applications.

For instance many image rendering processes are known, where image data information is transferred onto a photosensitive surface to form a latent image of the image data by using appropriate light sources. Finally in subsequent process steps a hardcopy of the image data is produced from this latent image.

Curing radiation curable resins by irradiation with light of appropriate wavelength is another example for such photochemical reactions. Here, a network of chemical bonds is formed in a more or less liquid resin by activating molecules by the absorption of photons of sufficiently high energy. Eventually the resin is turned into a material, which—compared with the initial state—is completely different in terms of its, e.g. mechanical, thermal, optical or chemical, material properties.

In both examples the ability to absorb light, and hence effect the desired photophysical or photochemical reaction, strongly depends on the wavelength of the incident light. Therefore the final result, i.e. the image and the properties of the cured material respectively, not only sensitively depends on the intensity of the applied light source, but also depends on the spectral distribution of the provided radiation.

In both examples the application of LEDs is adversely affected by the fact, that both intensity as well as spectral composition of the emitted light depend on factors like temperature and/or service life.

Therefore especially in these aforementioned fields many efforts were made to avoid or detect and—if applicable—compensate short and long term variations of intensity and spectral composition of solid state light sources like laser diodes and light emitting diodes (LED).

For example, an LED-printhead is described in U.S. Pat. No. 4,878,072, in which an array of LEDs is integrated with a light sensor in a single entity, to detect long term changes in the output power of individual LEDs due to aging. The measured values are compared with reference values stored in a memory, which is also integrated into the printhead. Finally the operating parameters of each individual LED are adjusted according to the mismatch of measured values and reference values to compensate for the degradation of output intensity over time.

A disadvantage of this solution is, that the sensor captures only changes in output intensity but not in spectral composition. Also, light output power is only sporadically measured, allowing to detect long term effects due to aging. However short term changes caused by a temperature rise due to power dissipation during operation of the printhead will be neglected. Moreover, since data can only be read from the integrated non-volatile memory, the system is unable keep records of the decline of output power by permanently storing measured intensity values.

A solution for the problem of intensity change and spectral shift due to temperature change and aging of LEDs is given in U.S. Pat. No. 6,713,754. Here, the emission of an LED light source is continuously monitored by at least two light sensors with different spectral sensitivity. Changes in intensity will result in changes in the amplitude of the sensor values, whereas spectral shifts will affect the ratio of the measured values. By adequate, continuous adjustment of the operating parameters of the light source according to amplitude and ratio of the sensor values, the photochemical impact of the light source may be kept constant. As with the previously described system, the feedback signal for the operating parameter control loop of the LEDs is generated by external light sensors. However external light sensors are prone to staining if the system consisting of light source and light sensor is not hermetically sealed. Also, under continuous illumination the sensitivity of the light sensors may suffer from degradation as well. Therefore, the correlation between output intensity of the light source and output signal of the light sensors may no longer be maintained.

In U.S. Pat. No. 5,734,672 a laser array assembly is described, integrating a laser diode array, sensors and a non-volatile memory into a single unit, which is easy to exchange. The non-volatile memory may store both predetermined operating parameters as well as sensor values and operating conditions obtained throughout service life of the laser array assembly.

For applications, in which uniform illumination of larger areas is required, laser sources are often inapplicable. The reason for this is, that laser emission shows a high degree of coherence, which may lead to strong non-uniformity of radiant power on the illuminated surface due to interference.

Another drawback of semiconductor-lasers is the necessity to produce a state of population inversion required for lasing, which is setting high demands on the quality of the semiconductor material. Therefore only a limited choice of semiconductor-laser materials and hence output emission wavelengths is available compared with light emitting diodes.

Finally in all three of the cited patents the intrinsic condition of the emitting semiconductor is monitored only by external sensors, which may not always be sufficient, as will be explained in the following description of the present invention.

It is therefore an object of the present invention to provide an easily exchangeable semiconductor emitter module, which emits incoherent electromagnetic radiation and includes means to monitor characteristic parameters as directly as possible, allowing to adjust the operating parameters such, that the short and long term photochemical or photophysical impact of the emitted radiation is kept stable.

### SUMMARY OF THE INVENTION

An easily interchangeable semiconductor emitter module according to a first preferred embodiment of the present invention comprises one or more light emitting diodes (LEDs), which emit incoherent electromagnetic radiation upon supply with electrical power. The LEDs are electrically connected to the substrate on which they are mounted. The module further includes at least one sensor for sensing physical parameters of the module, such as the temperature of the module. The sensor may either be mounted onto the same substrate as the LEDs or may be in contact with an additional supporting body also carrying the substrate. To provide an electrical interface of the module to power supplies and control units a releasable connector is further included, which is directly attached to the substrate, the additional supporting body or additional electrical conducting means.

In a second preferred embodiment of the present invention the semiconductor emitter module further includes an electronic memory component for storing information related to the operational parameters and operational condition of the module. Preferably both read and write operations may be performed on the memory component, which preferably is of a non-volatile type.

An LED operating device according to a third preferred embodiment of the present invention comprises an LED module including one or more LEDs on a substrate and a releasable connector, which is connected to an operating unit including a power supply and a controller.

In a fourth preferred embodiment of the present invention the LED operating device further includes one or more sensors integrated into the operating unit, which preferably monitor the forward voltage and optionally the operating current of the LEDs on the LED module. Every change in temperature in the LED semiconductor will result in a change of the forward voltage at a given operating current. Thus, the controller calculates a temperature change from any detected change in forward voltage, to initiate a control reaction in response to the determined temperature change.

In a fifth preferred embodiment of the present invention the LED operating device further includes an electronic non-volatile memory component on the LED module, operatively coupled to the controller in the operating unit, to retrieve parameters relevant to the operating parameters of the LED operating device and/or characteristic data referring to the correlation of sensed values to the intrinsic state of the LEDs and/or an output characteristic of the LEDs, to initiate a control reaction by the controller in response to parameters derived from the characteristic data and the sensed values.

In a sixth preferred embodiment of the present invention the electronic memory further is re-writable and data referring to operating parameters or sensor values of the LED operating device are recorded in the electronic memory during service life of the LED operating device.

In a seventh preferred embodiment of the present invention the LED operating device further includes one or more sensors integrated into the LED module, operatively coupled to the controller in the operating unit, for sensing physical parameters of the LED module, preferably a reference temperature of the LED module.

In an eighth preferred embodiment of the present invention the controller further determines an aging characteristic of the LED semiconductor by comparing sensed forward voltage values at sensed reference temperature values to predetermined characteristic data retrieved from the non-volatile electronic memory. The controller further initiates a control reaction in response to the determined aging characteristic of the LED semiconductor.

### BRIEF DESCRIPTION OF THE DRAWINGS

The present invention will be described in the following in more detail with reference to the following drawings:

FIG. 1A shows a schematic drawing of an LED module according to a first embodiment of the present invention including additional supporting means with a directly attached connector.

FIG. 1B shows a schematic drawing of an LED module according to the first embodiment of the present invention including additional supporting means with the connector attached via electrical conducting means.

FIG. 1C shows a schematic drawing of an LED module according to the first embodiment of the present invention including several LEDs without additional supporting means.

FIG. 1D shows a schematic drawing of an LED module according to the first embodiment of the present invention including an LED in direct contact with the substrate, additional supporting means and a printed circuit board (PCB) thereon carrying the connector, being in electrical contact with the substrate via flexible conducting means.

FIG. 2A shows a schematic drawing of an LED module according to the second embodiment of the present invention including a memory device mounted on additional supporting means.

FIG. 2B shows a schematic drawing of an LED module according to a second embodiment of the present invention including a memory device mounted on the connector being attached to the module via electrical conducting means.

FIG. 3 shows a schematic drawing of an LED operating device according to embodiments 3-8 of the present invention.

FIG. 4 shows a typical correlation of LED forward voltage and junction temperature of the LED semiconductor at different operating currents.

FIG. 5 shows a typical curve of LED forward voltage versus time for a pulse like application of LED operating current.

FIG. 6 shows a typical long term correlation of LED forward voltage and time at a specific LED operating current and junction temperature.

FIG. 7 shows a typical correlation of LED output intensity and junction temperature of the LED semiconductor.

FIG. 8 shows a typical shift of the peak-wavelength of the optical output of an LED versus junction temperature of the LED semiconductor.

### DETAILED DESCRIPTION OF THE INVENTION

Generally this invention refers to light sources incorporating light emitting diodes (LED). Within the scope of this invention the term light emitting diode or LED shall cover semiconductor diodes emitting incoherent electromagnetic radiation not only in the visible range of the electromagnetic spectrum but also in the whole ultraviolet and the near and mid infrared range. Also it shall be noted here that, whenever the term light emitting diode or LED is used in the description of the present invention, it explicitly includes light emitting diode semiconductors in any type of package, like for example, in a lead frame, packaged as a surface mounted device or as bare dice, each package incorporating at least one light emitting diode semiconductor chip.

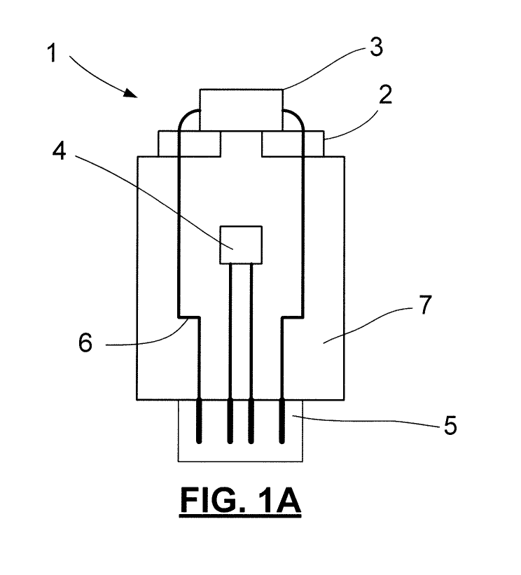

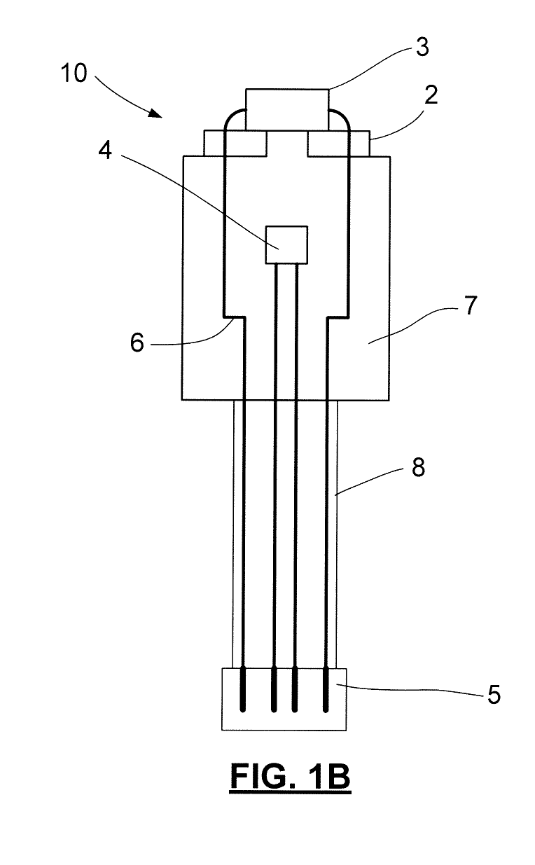

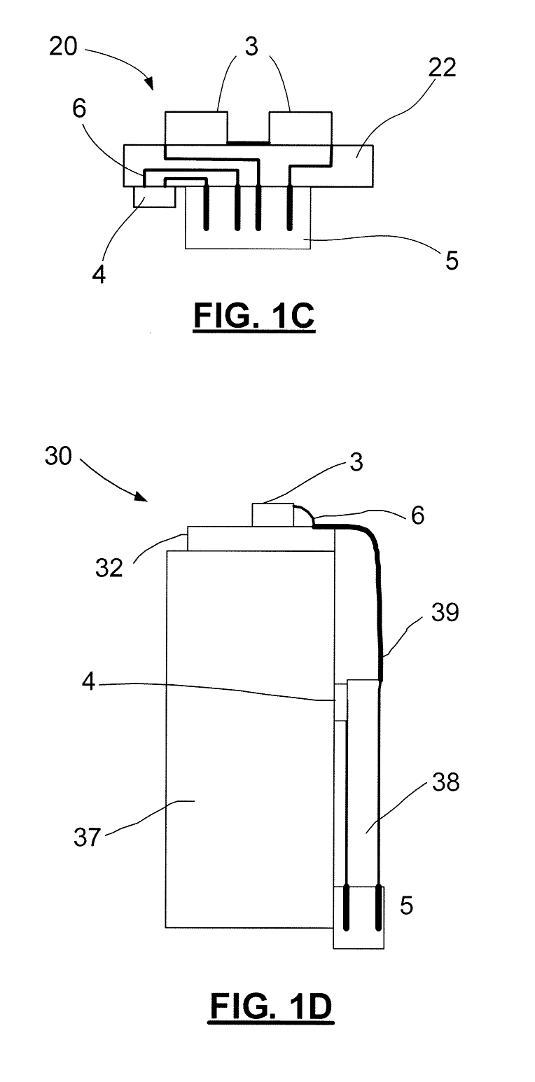

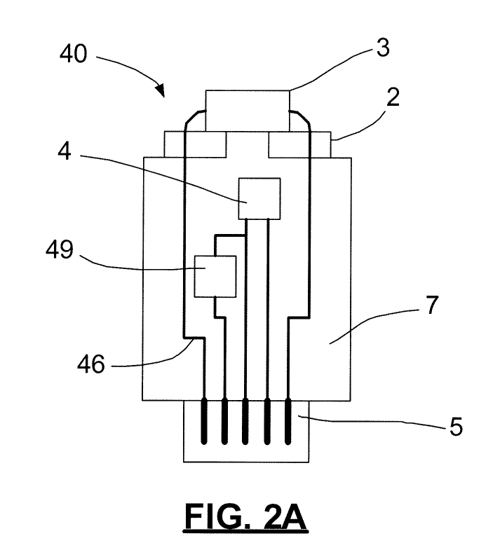

In FIG. 1A an LED module 1 according to a first embodiment is shown. The module comprises a substrate 2 on which an LED 3 is mounted. Even though only one LED 3 is shown here, an LED module 1 according to the present invention of course may include several LEDs 3 mounted onto the substrate 2 as well. The substrate 2 for example is a standard printed circuit board, providing electrical contacts and leads for electrically contacting the LED 3.

Adjacent to the substrate 2, a supporting body 7 is provided, which preferably is in direct contact with the LED 3, to efficiently remove heat from the LED 3, which is generated during operation of the LED module 1. For better heat removal the supporting body 7 is preferably made of a thermally conductive material, e.g. metals such as aluminum or copper or alloys of these metals or thermally conductive ceramic materials such as alumina or aluminum nitride, or composite structures incorporating elements of high thermal conductivity.

Further at least one sensor 4 is included in LED module 1. This sensor senses physical characteristics of the LED module 1 such as output intensity, output wavelength, spectral composition of the light output or a temperature. Several different types of sensors 4 may be included to sense different parameters on the same module, but also several sensors 4 of the same type may be included for sensing one parameter at different locations of the LED module 1. If the sensor 4 is a temperature sensor, the sensor 4 preferably is in good thermal contact to the LED 3 or at least the supporting body 7.

To supply the LED 3 with electrical power, the LED 3 is in electrical contact with the substrate 2, which is electrically coupled to a connector 5 by electrical conductors 6. The sensor 4 is also electrically coupled to the connector 5 via electrical conductors 6, thus forming an electrical interface to an external supply of electrical power to the LEDs and an external receiver of sensor value information. The conductors 6 may be for example wires or the metallization of a standard rigid printed circuit board. Alternatively a flexible or at least partially flexible printed circuit board may be used to provide the conductors 6. In the latter case the flexible part may serve to bridge the mechanical interface between substrate 2 and supporting body 7. The connector 5 is made such, that it can be coupled electrically to an external unit in releasable manner. Thus it is easily possible to interchange LED modules 1 with different output wavelength, intensity or angular beam pattern or to exchange LED modules 1 at the end of their service life.

In this and all of the following examples the substrate bulk material or at least parts of it are preferably electrically insulating to allow electrical separation of conductors 6 with different voltage potential.

In FIG. 1B an LED module 10 of almost the same configuration as in FIG. 1A is shown. However, instead of attaching the connector 5 directly to the supporting body 7 of the LED module 10, an electrical conductor 8 is provided between the supporting body 7 and the connector 5. Conductor 8 may be a rigid structure, such as a standard printed circuit board, but preferably the conductor 8 is flexible to simplify installation of the LED module 10. Such a flexible conductor 8 may be constituted by a flexible printed circuit board or a cable assembly.

FIG. 1C shows an LED module 20, in which all relevant components are in direct contact with the substrate 22. Just to exemplify various LED configurations, here two LEDs 3 are shown, which are directly mounted onto the substrate 22. To remove heat from the LEDs 3 the substrate 22 preferably consists of a thermally conductive material like a thermally conductive ceramic material such as alumina or aluminum nitride or a composite structure like for example a base made of metals with high thermal conductivity such as aluminum or copper or an alloy of these metals and an electrically insulating structure. Adjacent to the substrate a sensor 4 is provided, which has the same function as the sensor 4 in FIG. 1A. Again of course several sensors 4 of different type or of the same type may be incorporated in the LED module 20. Electrical conductors 6 are also included to provide electrical circuitry to couple the LEDs 3 and the sensor 4 to a connector 5 which may be releasably coupled to an external unit. Even though it is not shown here, an intermediate conductor between the substrate 22 and the connector 5 like in FIG. 1B may be used as well to simplify installation of the LED module 20.

FIG. 1D shows another version of the LED module 30. The LED 3 is in direct contact with a substrate 32, which preferably consists of a thermally conductive and at least partially electrically insulating material as described above. Since many substrate materials like ceramics are delicate to handle, especially when a planar substrate is used, an additional supporting body 37 is provided, which is in direct contact with the substrate 32. Supporting body 37 may serve as a thermal interface with a larger surface than the substrate 32, thus improving heat flow to the ambient. Therefore it is preferably made of thermally conductive materials like metals, ceramics or composite structures.

Electrical conductors 6 are provided to electrically contact the LED 3. To connect the conductors 6 to the connector 5 a more or less rigid electrical conductor structure 38 and a flexible electrical conductor structure 39 are provided. The rigid conductor structure 38 may, for example, be a rigid printed circuit board, which is mounted to the supporting body 37. Preferably a sensor 4 is mounted to the rigid conductor 38, as well as to the connector 5. Thus the rigid conductor structure 38 may serve as a mechanical mounting structure for the connector 5 and the sensor 4, bringing the sensor 4 into a well defined position in relation to the supporting body 37. The flexible conductor 39 may for example consist of a cable assembly or a flexible printed circuit board. Using a flexible conductor simplifies electrical bonding of the conductor to the substrate 32, especially when a ceramic substrate is used, and reduces mechanical stress between the supporting body 37 and the electrical interfacing structures.

Compared to semiconductor emitters of the prior art, LED modules 1, 10, 20 and 30 according to the first embodiment of the present invention emit incoherent radiation allowing to illuminate larger areas without any non-uniformity in intensity due to interference.

Moreover, directly incorporating sensors 4 into the LED module 1, 10, 20 and 30 guarantees that LED 3 and sensor 4 remain in a fixed spatial relationship, even when the LED module 1, 10, 20 or 30 is being moved or exchanged. For example, if sensor 4 is an intensity or spectral sensor, it will always capture the same fraction of solid angle of the LED emission. Since changes in the output characteristic of an LED, like intensity or emission spectrum, typically occur for all output angles in the same way, it is thus easily possible to accurately and continuously monitor relative changes of these output characteristics by light sensors in a fixed spatial relationship to the LED.

Equally a close and fixed spatial relationship of LED and sensor is important for temperature sensors. As will be explained later, output intensity and emission spectrum of LEDs are rather sensitive in a well defined functional relation to temperature changes in the pn-junction of the LED semiconductor. Also junction temperature is a major determinant for the long-term degradation of the LEDs output characteristic. Therefore precise knowledge of the temperature condition in the pn-junction allows to derive corresponding output intensities, spectral characteristics and degradation rates of these parameters.

A temperature sensed by an external sensor 4 will be only a representative of an LED's junction temperature at best. To come as close as possible temperature sensor and LED need optimal thermal coupling. To accomplish this, the distance between LED and sensor must be small and the intervening materials must have high thermal conductivity without exception. For an LED module which should be interchangeable or even movable during operation these preconditions can only be met with an external temperature sensor, if the sensor is directly incorporated into the module.

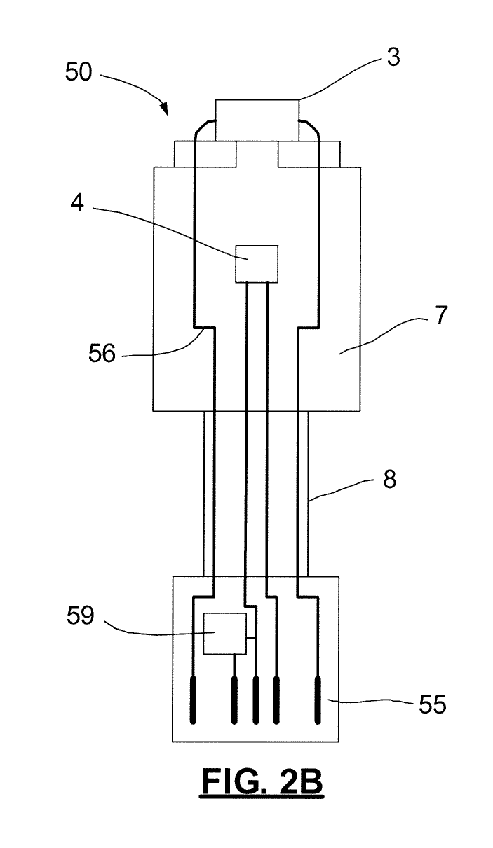

Referring now to FIG. 2A another preferred embodiment of the present invention is shown. An LED module 40 comprises a supporting body 7, which is in direct contact with at least one LED 3. Again supporting body 7 is made of a material with high thermal conductivity as described above. The LED 3 is electrically coupled to a substrate 2 to supply the LED 3 with electrical power. The substrate 2 is in electrical contact with a connector 5 via electrical conductors 46. Adjacent to the supporting body 7 one or more sensors 4 are included to sense physical characteristics of the LED module 40 as described above.

Sensor 4 is also electrically coupled to the connector 5 via conductors 46. The connector 5 may be coupled in releasable manner to an external unit to provide power and control signals to the LED module 40. Electronic information storage means 49 are further included, also being in electrical contact with the connector 5 via electrical conductors 46.

Generally the electronic information storage means 49 may comprise volatile types of electronic memory devices such as RAM devices to store for example sensor values during operation of the LED module 40. Preferably however the electronic information storage means 49 is of a non-volatile type, such as a ROM, EPROM, EEPROM or FRAM device, which will retain electronic information even when no electrical power is provided to the LED module 40. Non-volatile information storage means 49 allow to permanently store characteristic data of the LEDs 3 incorporated into the LED module 40. Among these may be for example the correlation between output intensity and LED junction temperature or output emission spectrum and junction temperature.

Via connector 5 these data as well as the sensed sensor values may be retrieved by an external control which may derive the state of output characteristic of the LEDs from this input. This state of output characteristic may be recorded or displayed by the control for further use and/or the control may—upon request or automatically—compute new output parameters for driving the LED module, like forward current or temperature, to achieve the desired output characteristic of the LEDs. Characteristic data on the correlation of output parameters and state of output characteristic, like the correlation of output intensity and forward current or output emission spectrum and forward current, which are required to compute appropriate output parameters, may be stored in and retrieved from the non-volatile memory device 49 as well.

FIG. 2B shows another version of the second embodiment. Here the connector 55 is not directly attached to the supporting body 7. Like in FIG. 1B an intermediate conductor 8 is provided to electrically couple the conductors 56 at the supporting body 7 with the connector 55. The intermediate conductor 8 again may be a rigid structure, such as a standard printed circuit board, but preferably the intermediate conductor 8 is flexible, for example a flexible printed circuit board or cable assembly, to simplify installation of the LED module 50.

In this case the electronic information storage device 59 is not directly attached to the supporting body 7, but is located in or at the housing of the connector 55 as indicated by FIG. 2B. An advantage of this solution is, that information storage devices 59 are still attached to the complete LED module 50 in a fixed manner, thus allowing for example to hold data, which are specific for each LED module 50, and at the same time physically separating information storage devices 59 from the rest of the LED module, allowing to keep the rest of the LED module as compact as possible and avoiding exposure of the information storage devices 59 to heat from the LEDs 3.

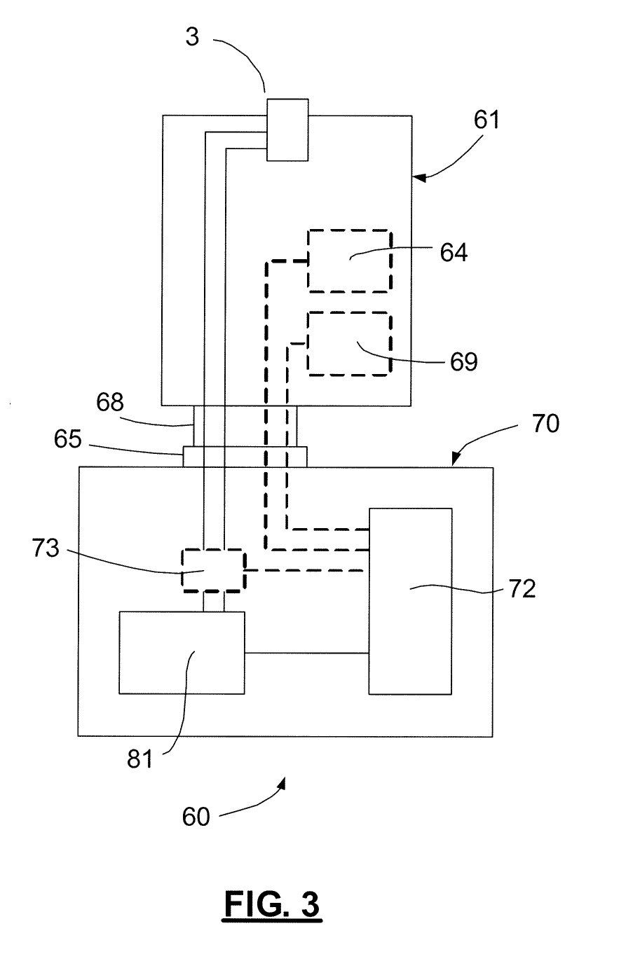

Referring now to FIG. 3 an LED operating device 60 according to further embodiments of this invention is schematically shown. The LED operating device 60 comprises an LED module 61, which is electrically coupled to an operating unit 70 via a connector 65 in releasable manner.

According to a third embodiment of the present invention the LED module 61 includes one or more LEDs 3 on a substrate which are electrically coupled to the connector 65. As shown in FIG. 3 an additional and preferably flexible conductor 68 may constitute the fixed electrical interface between the connector 65 and the supporting body of the LED module 61. The LED module 61 is supplied with electrical power by an operating unit 70, which includes a power supply 71 and a controller unit 72. The power supply 71 provides electrical power to the LEDs 3 on the LED module 61 via the connector 65. Preferably the power supply 71 includes a constant current source to supply the LEDs 3 with a defined forward current.

Even though only one LED 3 is shown in FIG. 3 the LED module 61 may comprise a plurality of LEDs. Current may be supplied to each of these LEDs individually or in groups. Hence also a plurality of constant current sources may be included in the power supply unit 71.

Operation of the power supply 71 is controlled by the controller unit 72. For example the controller unit 72 is sending electrical signals to define the level of current provided by the constant current source in the power supply unit 71.

An LED operating device 60 according to a fourth embodiment of the present invention further includes one or more sensors 73 in the operating unit 70 for sensing operational conditions of the operating device 60. Examples for these operational conditions are forward voltage or forward current supplied to the LEDs 3 by the power supply unit 71.

The sensor values from the sensor 73 are transmitted to the controller unit 72 for further processing. The sensor values may be used by the controller as a feedback signal to determine whether output current or output voltage are provided by the power supply unit 71 as preset by the controller unit 72. Thus, in the case of a mismatch of sensed and preset values, the controller unit 72 is able to detect a state of malfunction of the power supply unit 71. The controller may transmit such a state as an electronic signal to external entities and/or may display information regarding such a state on the operating device via optical or acoustic indicators or via optical display (not shown).

However, as indicated in the description of the first embodiment, there is much more information in the forward voltage of the LEDs than just the integrity of the power supply unit 71.

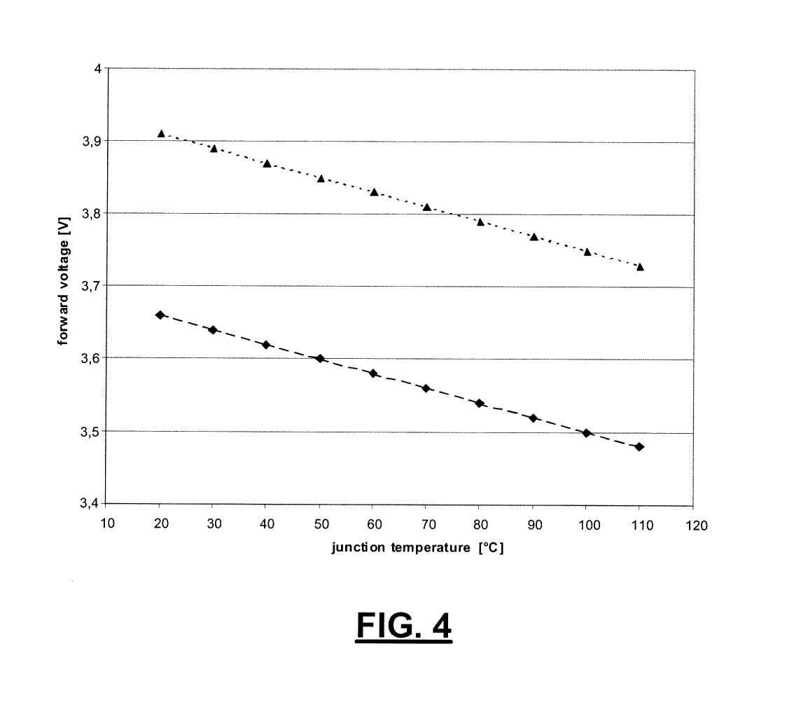

FIG. 4 shows for example the almost linear correlation of the temperature of the pn-junction of the LED semiconductor and the forward voltage, i.e. the voltage drop across the electrodes of the LED semiconductor, at two different LED forward currents. For each forward current value such a curve can be obtained. Slope and starting voltage value at a given current value are characteristic for each type of LED semiconductor. By obtaining the forward current during operation either by using the preset value from the controller or by sensing the actual current with an appropriate current sensor 73, the corresponding forward voltage curve as in FIG. 4 may be selected from the plurality of curves in a first step.

In a second step, by sensing the forward voltage and comparing the sensed value with the corresponding curve, the temperature right inside of the LED semiconductor may be obtained. In this way the LED semiconductor may serve as its own temperature sensor. Compared with prior art methods of sensing the LED junction temperature by external temperature sensors, this method offers much more direct access to the actual temperature in the pn-junction, which at the same time is also the light emitting volume of the LED semiconductor.

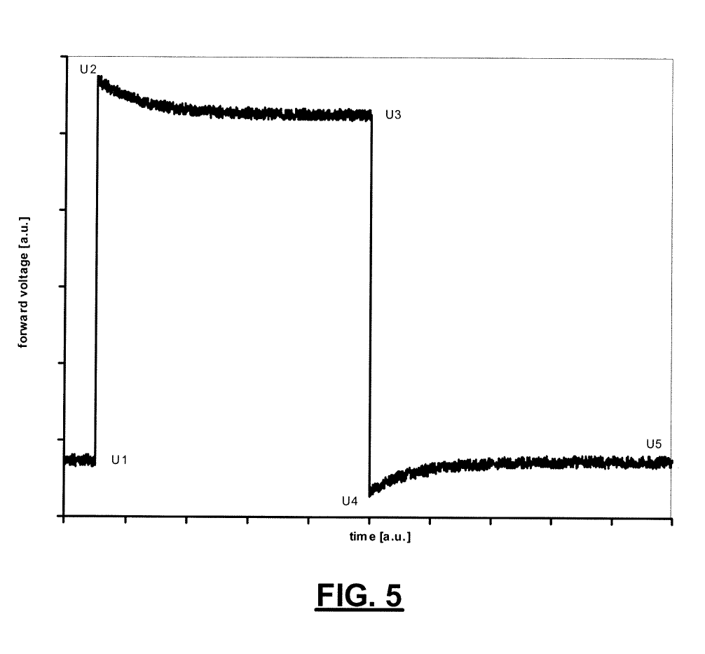

By continuously monitoring the forward voltage at a sufficiently high sampling rate the controller unit 72 may even record the LED junction temperature over time. An example for a typical forward voltage curve over time is shown in FIG. 5. At the beginning the LED is operated at a first and rather low current, with very low or even no emission of light. The voltage level sensed by the voltage sensor 73 at this moment is denoted as U1. Then the forward current is almost instantaneously raised to a second, higher current, making the LEDs emit light at a substantial level. The forward voltage rises to level U2 due to a higher forward current.

The junction temperature at the time of sensing U1 and U2 is practically the same. However due to the higher operating current much more heat is generated inside of the LED semiconductor causing the junction temperature to rise. According to the forward voltage curves of FIG. 4 this leads to a drop in forward voltage to level U3, even though the forward current remains stable. Then the LEDs are driven again at the first forward current level leading to a subsequent drop in forward voltage to level U4, which is lower than U1 at the same forward current level, because the junction temperature still has the same level as right at the end of the high current pulse. Finally the forward voltage returns to level U5, which is substantially identical to level U1, as the LEDs cool down to their initial junction temperature.

The amplitude of the detected change in forward voltage when the LEDs are energized as well as the rate of this change depend on the power dissipated as heat in the LED and the thermal conductivity of the heat transfer path from LED to ambient. Since the dissipated heat is known from the electrical input power, given by forward voltage and forward current, changes in the thermal constitution of the LED module 61 may be derived by the controller by analysing the amplitude and/or slope of the forward voltage change observed upon energizing the LEDs. In the case of an abnormal change, the controller may issue a warning signal and/or terminate or reduce power supplied to the LEDs.

Thus forward voltage serves as a powerful monitoring tool for the complete heat transfer path, and not only for heat transfer from housing to ambient as in prior art light sources. In addition a detailed numerical analysis of forward voltage versus time performed by the controller unit 72 may even yield insight into the heat transfer capacity of every single component in the heat transfer path, allowing to pin-point every heat barrier in the heat transfer path. It should be pointed out, that for an analysis of the thermal condition of the LED module 61 it is sufficient just to know the slope of the forward voltage curves in FIG. 4, which significantly reduces the required amount of characteristic parameters.

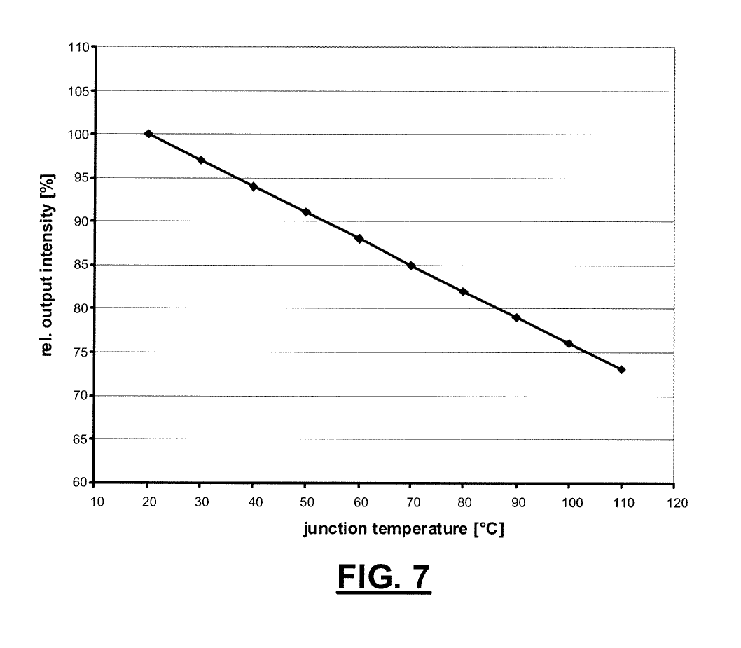

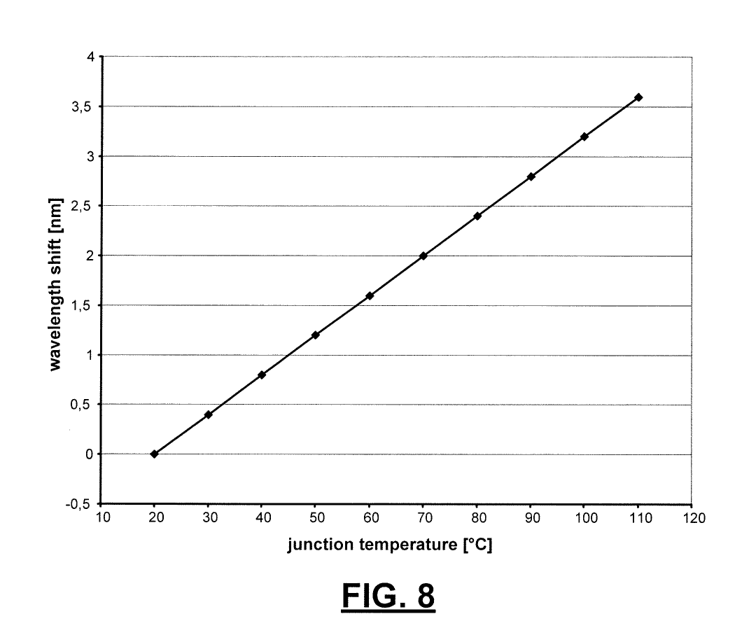

FIG. 7 and FIG. 8 show typical characteristic curves of the correlation of junction temperature to output intensity and shift of output wavelength respectively, at a given forward current. By combining the junction temperature derived from forward voltage as described above with these characteristic curves, it is effectively possible to determine optical output characteristics of the LED emitters by using a voltage sensor, which is not prone to staining as optical sensors of prior art do. Hence by monitoring changes in LED forward voltage the controller may compute changes in junction temperature and finally determine associated changes in output intensity and emission spectrum. In response to these changes the controller may change the operating parameters of the LED module to keep a characteristic like output intensity or wavelength stable. For example these operating parameters may be forward current or temperature, provided the LED module incorporates means to change temperature like a heater or an active cooler.

According to a fifth embodiment of the present invention the LED module further includes an electronic information storage device 69 electrically coupled to the connector 65 via conductors 68 and coupled to the controller unit 72. The memory device 69 preferably is of a non-volatile type as described in the second embodiment. The electronic memory device 69 may store one or more out of preset characteristic parameter sets like forward voltage versus forward current at one or more different temperatures, junction temperature versus forward voltage at one or more different forward currents, output intensity versus junction temperature at one or more different forward currents or a characteristic of the emission spectrum, like peak wavelength or spectral bandwidth, versus junction temperature.

These parameter sets may be identical for all LED modules incorporating the same type of LED semiconductor or they may be determined individually for every LED module during manufacturing and stored in the memory device as factory setup values. The controller unit 72 may read these characteristic parameter sets from the memory device 69 during operation to derive the thermal constitution of the LED module 61 and/or corresponding output characteristics of the LEDs as described above. Of course other preset values may be stored in the memory device 69 as well, like one or more out of LED module identification number, data on type of LED semiconductor, output power and emission spectrum, threshold values for forward current and junction temperature.

According to a sixth embodiment of the present invention data on the electronic information storage device 69 are re-writable. Thus the controller may not only read characteristic data of the LED-module for processing sensor values, it may also update these characteristic data according to corresponding sensor values. Additionally the controller 72 may record the history of the LED module by writing data into the memory device 69 associated with occurrences of malfunctions of the LED module 61 or the operating unit 70, or events of over-current, over-voltage or over-temperature with respect to preset threshold values. Finally the controller unit 72 may keep records of sensed operating parameters and sensed or computed LED output characteristics like forward current, forward voltage, temperature, output intensity or emission spectrum by storing one or more of these parameter values at periodic operating time intervals into the memory device 69.

In a seventh embodiment of the present invention the LED module 61 further includes one or more sensors 64 to sense physical characteristics of the LED module 61. As illustrated in FIG. 3 the sensor 64 is electrically coupled to the connector 65 via conductor 68 and eventually coupled to the controller unit 72 in the operating unit 70. The controller unit 72 receives sensor signals corresponding to the sensed values.

Additionally to the information derived from sensing the LED forward voltage as described in the previous embodiments the sensor 64 serves as a source of reference data.

For example the sensor 64 may be a temperature sensor recording a temperature of the LED module at a given distance from the LEDs 3. As long as the LEDs 3 are not supplied with power, the temperature sensed by the sensor 64 and the junction temperature of the LEDs 3 are more or less identical. As outlined above with reference to FIG. 5 the junction temperature before a forward current pulse is applied and the junction temperature right at the beginning of a forward current pulse are also identical.

Therefore, by sensing an LED module temperature with sensor 64, applying a forward current pulse and sensing the forward voltage across the LED 3 with sensor 73 before the forward current pulse is applied and right at the beginning of the forward current pulse the characteristic curve of forward voltage versus junction temperature can be redetermined.

In order to avoid measurement errors, the forward current in the forward current pulse must reach stable values significantly faster than the change in junction temperature occurs. Also the time required by sensor 73 to obtain stable forward voltage sensor values must be significantly shorter than the rate at which junction temperature rises. For a typical LED setup this junction temperature rise occurs at rates ranging from of a few milliseconds to a few seconds. Therefore the sampling rate of sensor 73 to obtain forward voltage values should be at least 100 Hz and preferably higher than 1 kHz.

In the same way the characteristic parameter sets for forward voltage versus forward current at one or more different temperatures may be determined as well as output intensity versus junction temperature at one or more different forward currents or a characteristic of the emission spectrum, like peak wavelength or spectral bandwidth, versus junction temperature, if sensor 64 further includes sensors for optical output power and emission spectrum respectively. Of course these optical sensors preferably are capable of sensing corresponding optical characteristics in a time resolved manner.

Redetermination of characteristic parameter sets may be initiated by the controller unit 72 at regular time intervals. After redetermination of a characteristic parameter set the controller unit 72 may store these updated parameter sets in the memory device 69 for further use.

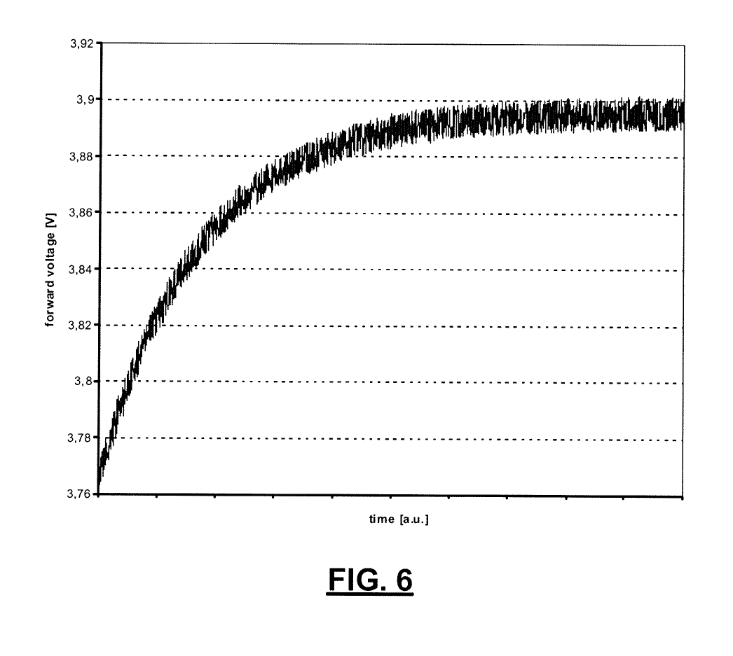

As shown in FIG. 6 forward voltage at a given forward current and a given junction temperature performs a long term drift. This drift occurs due to aging processes in the LED semiconductor. The long term change in forward voltage is accompanied in close correlation by a degradation of output intensity and/or changes in the emission spectrum, like a drift in peak wavelength or emission spectrum bandwidth.

The aging processes of the LED semiconductor strongly depend on operating conditions like amplitude of forward current and junction temperature. A functional correlation of forward voltage drift and time as shown in FIG. 6 is only observed, if forward current and junction temperature are kept stable over time. Typically this drift occurs on a time scale of hundreds of operating hours. In most applications however forward current and junction temperature are not constant. Therefore a functional correlation of aging and operating time, and hence output intensity degradation and change of emission spectrum, does not necessarily exist.

To overcome this problem, the controller unit 72 obtains in an eighth preferred embodiment of the present invention a reference temperature of the LED module 61 from sensor 64 and senses the corresponding forward voltage with sensor 73, by applying a forward current pulse as outlined above, assuming that the junction temperature at the beginning of the forward current pulse and the reference temperature are virtually identical. Forward voltage values and corresponding junction temperature values are stored in the memory device 69 in the LED module 61 at regular intervals. Thus, the long term drift of forward voltage due to aging of the LED semiconductor is recorded.

By comparing stored forward voltage values to the current forward voltage values at a given junction current, the controller unit 72 determines the amount of forward voltage change. According to predetermined characteristic correlation parameters, stored in the memory device 69, the controller unit 72 derives the amount of output intensity degradation or change in emission spectrum from the amount of forward voltage change. Subsequently the controller unit 72 determines new operating parameters, like the LED forward current supplied by the power supply unit 71 or the temperature of the LED module 61, provided the LED module incorporates means to change temperature like a heater or an active cooler controlled by the controller unit 72.

Thus, by directly monitoring the electrical parameters of the LED semiconductor, the output characteristics of the LED module 61 may be kept stable, despite of short term changes of junction temperature and long term degradation due to aging.

Of course it will be understood by anyone skilled in the art that various changes can be made from these preferred embodiments, which still fall within the scope of this invention.

What is claimed is:

1. An LED module comprising:
a substrate;
a light emitting diode mounted to and in electrical contact with said substrate for emitting incoherent electromagnetic radiation when energized with electrical power;
sensor means for sensing a physical characteristic, in particular the temperature, of the LED module; and
interface means for electrically connecting the LED module releasably to an operating system, said interface means being in electrical contact with said substrate and said sensor.

2. An LED module according to claim 1, further comprising thermally conductive supporting means, wherein at least one of said sensor means and said light emitting diodes are in thermal contact with said supporting means.

3. An LED module according to claim 2, wherein
said substrate is made of a thermally conductive and electrically insulating material, particularly a ceramics material,
said substrate is sandwiched between said light emitting diode and said supporting means;
said interface means comprises electrical conductors which are at least partly embedded in a rigid electrical conductor structure, preferably a printed circuit board;
said rigid electrical conductor structure is mounted to said supporting means, and
said sensor is sandwiched between said rigid electrical conductor structure and said supporting means.

4. An LED module according to claim 1, wherein
said sensor means is mounted onto said substrate, and
said substrate is preferably thermally conductive

5. An LED module according to claim 1, further comprising storage means for storing electronic information, said storage means being in electrical contact with said interface means.

6. An LED module according to claim 5, wherein
said storage means is adapted to retain the electronic information when no electrical power is supplied, and
the electronic information is preferably written to said storage means, when said storage means is supplied with electrical power.

7. An LED module according to claim 5, connected to said operating system to form an LED operating device, wherein
the electronic information stored in said storage means includes characteristic parameters which are specific to the LED module, and
said operating system is adapted to determine driving parameters of the light emitting diode, such as the driving current to be applied, based on said characteristic parameters and the physical characteristic sensed by said sensor means.

8. An LED operating device comprising an LED module and operating means, said LED module including a substrate, a light emitting diode mounted to and in electrical contact with said substrate for emitting incoherent electromagnetic radiation when energized with electrical power, and interface means for electrically connecting the LED module releasably to said operating means, said interface means being in electrical contact with said substrate,
said operating means including power supply means for supplying electrical power to said light emitting diode via said interface means, and control means for controlling the electrical power supplied to said light emitting diode by said power supply means.

9. An LED operating device according to claim 8, wherein
said operating means further includes means for measuring operational conditions of said operating means, and
said measuring means is operatively coupled to said control means to transfer measured values to said control means.

10. An LED operating device according to claim 9, wherein said measuring means includes a current sensor and is adapted to measure the operating current passing through said light emitting diode.

11. An LED operating device according to claim 9, wherein
said measuring means includes a voltage sensor and is adapted to measure the forward voltage of said light emitting diode,
said control means is preferably capable of sampling measurement values from said voltage sensor at a rate of at least one hundred per second, and
said control means preferably includes means for calculating a temperature change corresponding to a change in forward voltage of said light emitting diode measured by said voltage sensor.

12. An LED operating device according to claim 8, wherein
said LED module further comprises sensor means for sensing physical parameters of said LED module, and
said sensor means preferably includes a temperature sensor for sensing the temperature of said LED module.

13. An LED operating device according to claim 8, wherein
said LED module further includes storage means for storing electronic information and being in operational contact with said control means via said interface means,
said storage means is preferably adapted to retain electronic information when no electrical power is supplied, and
electronic information is preferably written to said storage means during operation of said LED operating device.

14. An LED operating device according to claim 11, wherein
said LED module further includes a temperature sensor for sensing a temperature of said LED module, and
said control means includes means for calculating an absolute temperature of the LED module by adding a calculated temperature change corresponding to a change in forward voltage of said light emitting diode measured by said voltage sensor to a temperature sensed by said temperature sensor.

15. An LED operating device according to claim 14, wherein
said LED module further includes storage means for storing electronic information and being in operational contact with said control means via said interface means, and
said storage means is adapted to retain electronic information when no electrical power is supplied.

16. An LED operating device according to claim 15, wherein said control means includes means for reading information regarding the correlation between the temperature of the LED module and at least one output characteristic of the LED from said storage means.

17. An LED operating device according to claim 16, wherein
said output characteristic is at least one of output intensity and output wavelength, and
said control means preferably includes means for calculating new operating parameters for the operation of said power supply means, and said control means is adapted to provide said operating parameters to said power supply means to compensate for a change of at least one of said output characteristics.

18. An LED operating device according to claim 11, wherein
said LED module further includes a temperature sensor for sensing a temperature of said LED module, and storage means being in operational contact with said control means via said interface means,
said storage means is adapted to retain electronic information when no electrical power is supplied,
said storage means includes means for updating electronic information during operation of said LED operating device,
said control means includes means for recording information corresponding to said measured forward voltage on said storage means, and
said control means preferably includes means for recording a total time of operation of said LED module.

19. An LED operating device according to claim 18, wherein
said information corresponding to said measured forward voltage as a function of the sensed temperature and the operating current of said LED module is updated at periodic intervals of the operation time of said LED module throughout the service life of said LED module, and
said control means preferably includes means for determining new operating parameters for the operation of said power supply means and for transferring said new operating parameters to said power supply means in response to a change in said forward voltage as a function of the sensed temperature and an operating current of said LED module according to predetermined data stored in said electronic information storage means to compensate for a change of at least one output characteristic of said LED module indicated by said change in forward voltage.

20. A method of operating an LED operating device comprising the steps of:
providing an LED module and an operating means; said LED module including a substrate, a light emitting diode mounted to and in electrical contact with said substrate for emitting incoherent electromagnetic radiation when energized with electrical power, and interface means for electrically connecting the LED module releasably to said operating means, said electrical interface means being in electrical contact with said substrate; said operating means including power supply means for supplying electrical power to said light emitting diode via said interface means, control means for controlling the electrical power supplied to said light emitting diode by said power supply means, and means for measuring operational conditions of said operating means, said measuring means being operatively coupled to said control means;
applying a forward current to said light emitting diode from said power supply means via said interface means according to operating parameters provided by said control means;
measuring at least one operational condition of said operating means, preferably the forward voltage applied to said light emitting diode, by said measuring means while applying said forward current.

21. A method of operating an LED operating device according to claim 20, further comprising the step of:
causing said control means to obtain default values for said operational condition as a function said operating parameters;
causing said control means to compare said default values with said measured operational condition; and
causing said control means to issue an electrical signal to an external entity, when a predetermined mismatch of said measured operational condition and said default values is detected.

22. A method of operating an LED operating device according to claim 21, further comprising the step of causing said control means to determine an operating state, preferably a temperature, of said light emitting diode from said operational condition and predetermined characteristic parameters.

23. A method of operating an LED operating device according to claim 22, further comprising the steps of:
providing, on said LED module, storage means for storing electronic information, said storage means being operationally coupled to said control means via said interface means and being capable of retaining electronic information, when no electrical power is supplied to said storage means;
storing at least one of said predetermined characteristic parameters in said storage means; and
causing said control means to read said predetermined characteristic parameter from said storage means.

24. A method of operating an LED operating device according to claim 23, further comprising the step of causing said control means to change said operating parameters, provided by said control means to said power supply means, in response to a change in said determined operating state of said light emitting diode.

25. A method of operating an LED operating device according to claim 24, wherein said determined operating state is at least one out of temperature, output intensity and a characteristic of the emission spectrum of said light emitting diode.

26. A method of operating an LED operating device according to claim 23, further comprising the steps of:
providing sensor means, which is located on said LED module and operatively coupled to said control means; and
causing said control means to read sensor values from said sensor means on said LED module.

27. A method of operating an LED operating device according to claim 26, wherein
said sensor means is at least one out of a temperature sensor and an optical sensor for detecting at least one of an LED output and characteristic of the LED emission spectrum, and
said sensor means is adapted to sense a characteristic corresponding to said determined operating state of said light emitting diode.

28. A method of operating an LED operating device according to claim 27, wherein electronic information may be both read form and written to said electronic information storage means, and said method further comprising the step of:
causing said control means to recalculate said predetermined characteristic parameter from said operational condition measured by said measuring means and said characteristic sensed by said sensor means; and
causing said control means to write said recalculated predetermined characteristic parameter to said electronic information storage means.

29. A method of operating an LED operating device according to claim 26, wherein electronic information may be both read form and written to said electronic information storage means, and said method further comprising the step of:
causing said control means to write electronic information corresponding to said operational condition measured by said measuring means and said sensor value sensed by said sensor means to said storage means.

30. A method of operating an LED operating device according to claim 26, further comprising the steps of:
causing said control means to read electronic information related to the correlation of said forward voltage and the sensor value from said sensor means from said storage means;
causing said control means to calculate a difference of the currently measured value of said forward voltage and a calculated value derived from the sensor values from said sensor means and said read correlation electronic information;
causing said control means to calculate a degradation in an operating state of said light emitting diode from said difference of forward voltages; and
causing said control means to change said operating parameters provided by said control means to said power supply means in response to said degradation in said operating state of said light emitting diode.
